(19) United States
(12) Patent Application Publication
(10) Pub. No.: US 2006/0013433 A1
(43) Pub. Date: Jan. 19, 2006

(54) Audio speaker cone appartus and method of manufacture

(76) Inventor: John G Harrison, San Rafael, CA (US)

Correspondence Address: Johnson & Stainbrook, 3558 Round Barn Blvd, Suite 203, Santa Rosa, CA, 95403, US

(21) Appl. No.: 10/523,774

(22) PCT Filed: Aug. 7, 2003
(86) PCT No.: PCT/US03/24738

§ 371 Date: Feb. 7, 2005

Related U.S. Application Data
(60) Provisional application No. 60/401,606, filed on Aug. 7, 2002.

(51) Int. Cl. H04R 25/00

(52) U.S. Cl. 381/432

(57) ABSTRACT

The invention provides for the construction of cones (12) of audio speaker (10) from at least some quantity of hemp fiber, alone or with other materials and/or binding chemicals. The hemp composition may range from approximately 2% to approximately 100% hemp fiber. The invention composition may be mixed, molded, pressed, and placed into a frame (14) in a traditional manner of speaker cone structure.

### CROSS-REFERENCES TO RELATED APPLICATIONS

This application claims the benefit of U.S. Provisional Application Ser. No. 60/401,606, filed 7 Aug. 2002.

### BACKGROUND OF THE INVENTION

1. Technical Field

This invention relates generally to audio speakers, and more specifically to an improved speaker cone apparatus and method for its construction.

2. Background Art

Audio speaker cones (also sometimes referred to as speaker diaphragms or acoustic diaphragms) are traditionally manufactured from common paper fiber which has been molded, pressed, and placed into a frame. However, known speaker cones often have undesirable tone characteristics and/or sonic properties (such as distortion or ghost notes), and are prone to deterioration and failure.

### DISCLOSURE OF INVENTION

The inventive method and apparatus provides for construction of audio speaker cones from at least some quantity of hemp fiber, alone or with other materials and/or binding chemicals. The hemp composition may range from approximately 2% to approximately 100% hemp fiber. In the preferred embodiment, the composition includes any proportion greater than 50% hemp fiber, e.g., approximately 80% hemp pulp, and 20% other material such as non-hemp paper pulp (such as Eucalyptus pulp) and binding chemicals (such as latex).

The inventive composition may be mixed, molded, pressed, and placed into a frame in the traditional manner of speaker cone construction, all as is well known in the industry. The material may be used for new or reconed guitar speakers, dust caps (e.g., one inch to seven inches in diameter), voice coils, home stereos, musical instrument speakers, or any other audio speakers or loudspeakers. The resultant speaker cones have been found to have superior tone and sonic properties (e.g., no distortion or ghost notes) and increased durability (e.g., increased power handling capability) when compared to other known speaker cone constructions.

Hemp is a cellulosic vegetable fiber, renowned for its higher strength and stiffness relative to wood based fiber (paper). The higher bending stiffness of hemp cones (relative to paper cones) results in higher flexural rigidity. Higher bending stiffness extends the cone's high frequency and operating bandwidth. Hemp fibers are also longer than paper wood fibers. The increased fiber length increases the tear resistance as well as fracture resistance of cones made from hemp. Finally, the speed of sound through hemp paper is higher than through ordinary wood-based paper. This decreases the phase difference between sound emanating from the cone apex and the cone edge. The decreased phase difference means less sound cancellation and more dispersion of acoustical energy.

### BRIEF DESCRIPTION OF THE DRAWINGS

FIG. 1 is a view of an audio speaker of this invention, illustrating a cone supported in a frame, connected to a magnet within a magnet cover.

### BEST MODE FOR CARRYING OUT THE INVENTION

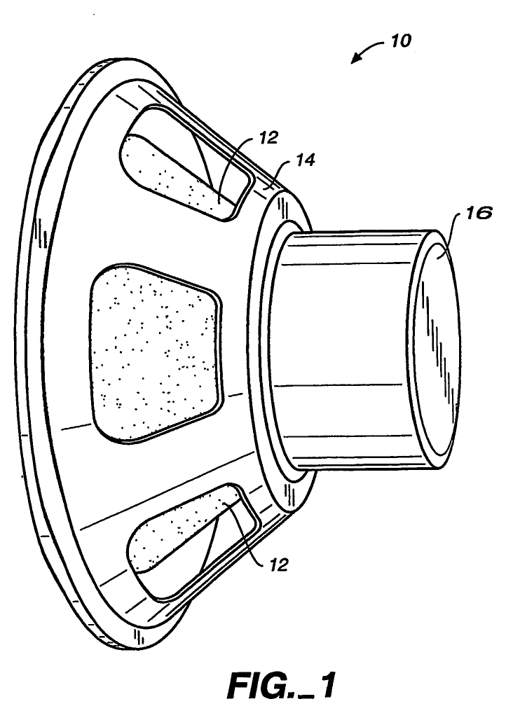

Referring to FIG. 1, the inventive audio speaker apparatus 10 includes a cone 12 supported in a frame 14, connected to a magnet (not visible in this view) within a magnet cover 16. The inventive apparatus in manufactured in the traditional manner of speaker and speaker cone construction, as is well known in the industry to which it pertains.

A preferred cone composition may consist of:

1. 80% Manila hemp;

2. 20% eucalyptus pulp;

3. 5% blue-black dye and yellow dye (for cone color);

4. 7% table salt (acts as dye wick);

5. 1-3% SB latex: glyoxal styrene butadeine (binder);

6. 0.5% AKD: alkyl ketene dimer base stearic acid (organic) (waterproofer);

7. 0.1% cationic polyamine (retention and sticks to fiber, good for drainage);

8. 0.1% anionic polyacryalmide (same); and

9. (Trace) enzyme, fungicide for white rot fungus.

(Note: these proportions are approximate.)

An alternate composition and method of manufacture for a hemp cone may consist of:

25 lbs (10 kg.) refiner, approximately 50-60 gallons water;

add: 2 kg. (4.5 lb) eucalyptus pulp, 8 kg. (17.5 lb.) Manila hemp (dry fiber), 150 ml. Buzyme 2526 (enzyme), recirculate (no refining)20 min.;

add: refine to 550 CSF;

add: 0.6 kg. (1.3 lb.) Black dye, 0.1 kg. (0.22 lb.) Yellow dye (for greenish color), 0.1 kg. (0.22 lb.) Salt, recirculate (no refining) for 10 min.;

add: 3 liters latex 68326 (SB Rubber emulsion) (binder), recirculate for 10 min.;

add: 3 liters Web Bond (Chitosan) (binder), recirculate for 10 min.;

add: 300 ml. Cypro 515 (cationic polyamine retention/drainage aid), recirculate for 5 min.;

add: 50 ml. Accurac 171 (anionic polyacrylamide retention/drainage aid), recirculate for 5 minutes;

cone dipped in 20-1 #5010 (microcellulose lacquer);

Fiber range ratio: 0-30% eucalyptus, 70-100% manila hemp.

A further alternate composition and method of manufacture for a hemp cone may consist of:

25 lbs (10 kg.) refiner, approximately 50-60 gallons water;

add: 2 kg. (4.5 lb) eucalyptus pulp, refine to 600 CSF;

add: 8 kg. (17.5 lb.) Manila hemp (dry fiber), refine to 500 CSF;

add: 0.6 kg. (1.3 lb.) Black dye, 0.1 kg. (0.22 lb.) Salt, recirculate (no refining) for 10 min.;

add: 3 liters latex 68326 (SB Rubber emulsion), recirculate (no refining) for 10 min.;

add: 3 liters Web Bond, recirculate (no refining) for 10 min.;

add: 300 ml. Cypro 515, recirculate (no refining) for 5 min.;

add: 50 ml. Accurac 171 RS, recirculate (no refining) for 5 minutes;

final pH 6.5-8.0, record final freeness;

dip cone body in 20-1 #5010 lacquer (20 parts acetone/1 part #5010)).

A still further alternate composition and method of manufacture for a high performance cone with carbon fiber reinforced hemp may consist of:

25 lbs (10 kg.) refiner, approximately 50-60 gallons water;

add: 8 kg. (17.5 lb.) Manila hemp (dry fiber), refine to 600 CSF;

add: 2 kg. (4.3 lb.) Carbon fibers, refine to approx 500 CSF (carbon fibers in a dilute water solution do not clump together);

add: 0.6 kg. (1.3 lb.) Black dye, 0.1 kg. (0.22 lb.) Salt, recirculate (no refining) for 10 min.;

add: 3 liters Web Bond, recirculate (no refining) for 5 min.;

add: 3 liters latex 68160, recirculate (no refining) for 5 min.;

add: 2 lb. (dry) alum, recirculate (no refining) for 10 min., final pH 4.5-5.0;

or add: 300 ml. Cypro 515, recirculate (no refining) for 5 min.;

add: 50 ml. Accurac 171 RS, recirculate (no refining) for 5 min., final pH 6.5-8.0, record final freeness;

dip cone body in 10-1 #5010 lacquer (10 parts acetone/1 part #5010)).

The raw materials for the above compositions may be as follows:

Wood fibers: northern softwood kraft pulp (Canfor, Weyerhaeuser, Dontar, Pope & Talbot, etc.).

Reinforcement fibers: manila hemp (Ahlstrom), eucalyptus pulp (Dave Hillman & Assoc.), carbon fibers (Fortafil) or fibrillated acrylic fibers (Engineered Fibers Technology).

Internal Cellulosic Crosslinkers: Latex 68160 (polystyrene emulsion) (Reichold), Latex 68326 (Styrene Butadience emulsion) (Reichold), Web Bond (chitosan) Marine Extract.

Retention/Drainage aids: alum (papermakers grade aluminum sulfate) acid papermaking, pH 4.5-5.0, Cypro 515, cationic polyamine plus Accurac 171 RS, anionic polyacrylamide (both from CIBA) neutral pH papermaking, pH 6.5-8.0.

Black dye: GX-CB (Crompton).

Salt: food or technical grade salt, catalyst for dye.

Miscellaneous: dipping lacquer (nitocellulose #5010, C.D. Moyen, external stiffening agent); acetone (for diluting #5010).

A twelve-inch full-range speaker designed for musical instrument use and incorporating the inventive speaker cone composition may consist of the following:

Frame: stamped rolled-steel frame with six spokes and holes for various mounting applications, outside dimension 12.1875 inches, height 3.625 inches.

Magnet: 2.25 lb. cylindrical torus permanent magnet, made of Nickel-Cobalt-Alloy (AlNiCo), outside dimension 4.0 inches, height 1.5 inches.

T-yoke: low-carbon steel one-piece assembly, with a threaded hole for a screw to hold the magnet cover, outside dimension 4.300 inches, height 0.312 inches, center pole dimension 1.734 inches, height 1.878 inches.

Top plate: low-carbon rolled steel, with holes threaded to receive screws for mounting the frame to motor assembly, outside dimension 4.300 inch, height 0.312 inch.

Magnet cover: non-ferrous (e.g., aluminum) cup held on to motor assembly with non-ferrous brass hardware and adhesive, diameter 4.875 inch, height 2.75 inch.

Motor: assembly of T-yoke, magnet and top plate. Mounted to frame by three motor screws.

Spider: phenolic treated cotton fabric, outside dimension 4.5 inches, internal dimension 1.75 inches, height 0.25 inches.

Pad ring sectors: four paper chip-board, height 0.25 inches.

Voice coil: two-layer copper wire wound on a Nomex support bobbin at 8 or 16 ohms, diameter 1.75 inches, height 1 inch, windings height 2.666 inches.

Cone: self-molded, seamless hemp fiber composite, outside dimension 11.625 inches, apex (opening) 1.75 inches, height 3.125 inches.

Wires: silver flexible tinsel lead wire.

Dome: phenolic treated cotton fabric, diameter 3.5 inches, height 0.5 inches.

Adhesives: rubber gasket adhesive, cyano-acrylate, PVA suspended in water.

The inventive cone composition can be utilized in any number of speaker cone sizes, including but not limited to 4 inch, 6 inch, 8 inch, 10 inch, 12 inch, 15 inch, and 18 inch. The cones may be smooth or ribbed, and may be made in any color. It has also been determined that the inventive cone apparatus yields even better performance when housed in a cabinet itself constructed of hemp materials, such as composite industrial hemp panels (e.g., conforming to ANSI M2 or M3 grades in ½ and ¾ inch thickness), otherwise constructed in a manner well known in the art.

Accordingly, the present invention may be characterized as a speaker cone comprising a hemp fiber in a concentration of at least 50%; a quantity of non-hemp paper pulp; and a quantity of binding material. The hemp fiber may be in a concentration of between 60% to 90%. The non-hemp paper pulp may comprise eucalyptus pulp in a concentration of between 1% and 40%, and the binding material may comprise latex in a concentration of between 1% to 10%.

Alternatively, the invention may be characterized as a speaker cone assembly comprising a paper-type cone positioned in a speaker frame, where the cone material is a composite of hemp fiber, non-hemp paper pulp, and binding material, and said hemp fiber is present at more than 50% of the final total dry weight of the composite.

Alternatively, the invention may be characterized as a method for manufacturing an audio speaker comprising the steps of providing a speaker cone comprising a hemp fiber in a concentration of at least 50%, and positioning the speaker cone in a speaker frame.

Alternatively, the invention may be characterized as a method for reconing an audio speaker comprising the steps of removing the speaker cone from an audio speaker frame, providing a replacement speaker cone comprising a hemp fiber in a concentration of at least 50%, and positioning the replacement speaker cone in the speaker frame.

The foregoing disclosure is sufficient to enable one having skill in the art to practice the invention without undue experimentation, and provides the best mode of practicing the invention presently contemplated by the inventor. While there is provided herein a full and complete disclosure of the preferred embodiments of this invention, it is not intended to limit the invention to the exact construction, dimensional relationships, and operation shown and described. Various modifications, alternative constructions, changes and equivalents will readily occur to those skilled in the art and may be employed, as suitable, without departing from the true spirit and scope of the invention. Such changes might involve alternative materials, components, structural arrangements, sizes, shapes, forms, functions, operational features or the like.

Accordingly, the proper scope of the present invention should be determined only by the broadest interpretation of the appended claims so as to encompass all such modifications as well as all relationships equivalent to those illustrated in the drawings and described in the specification.

What is claimed as invention is:

1. A speaker cone comprising:
a hemp fiber in a concentration of at least 50%;
a quantity of non-hemp paper pulp; and
a quantity of binding material.

2. The speaker cone of claim 1 wherein said hemp fiber comprises Manila hemp.

3. The speaker cone of claim 2 wherein said hemp fiber is in a concentration of between 60% to 90%.

4. The speaker cone of claim 1 wherein said non-hemp paper pulp comprises eucalyptus pulp.

5. The speaker cone of claim 4 wherein said eucalyptus pulp is in a concentration of between 1% and 40%.

6. The speaker cone of claim 1 wherein said binding material comprises latex.

7. The speaker cone of claim 6 wherein said latex is in a concentration of between 1% to 10%.

8. The speaker cone of claim 1 further including a dye material.

9. The speaker cone of claim 1 further including a water proofing material.

10. The speaker cone of claim 1 further including a fungicide.

11. A speaker cone assembly comprising a paper-type cone positioned in a speaker frame, where the cone material is a composite of hemp fiber, non-hemp paper pulp, and binding material, and said hemp fiber is present at more than 50% of the final total dry weight of the composite.

12. The speaker cone assembly of claim 11 wherein said hemp fiber comprises Manila hemp.

13. The speaker cone assembly of claim 12 wherein said hemp fiber is in a concentration of between 60% to 90%.

14. The speaker cone assembly of claim 11 wherein said non-hemp paper pulp comprises eucalyptus pulp.

15. The speaker cone assembly of claim 14 wherein said eucalyptus pulp is in a concentration of between 1% and 40%.

16. The speaker cone assembly of claim 11 wherein said binding material comprises latex.

17. The speaker cone assembly of claim 16 wherein said latex is in a concentration of between 1% to 10%.

18. The speaker cone assembly of claim 11 wherein said cone material further includes a dye material.

19. The speaker cone assembly of claim 11 wherein said cone material further includes a water proofing material.

20. The speaker cone assembly of claim 11 wherein said cone material further includes a fungicide.

21. A method for manufacturing an audio speaker, said method comprising the steps of:
providing a speaker cone comprising a hemp fiber in a concentration of at least 50%; and
positioning the speaker cone in a speaker frame.

22. The method for manufacturing an audio speaker of claim 22 wherein the step of providing a speaker cone comprising a hemp fiber further includes providing a quantity of non-hemp paper pulp in the speaker cone.

23. The method for manufacturing an audio speaker of claim 22 wherein the step of providing a speaker cone comprising a hemp fiber further includes providing a quantity of binding material in the speaker cone.

24. A method for reconing an audio speaker, said method comprising the steps of:
removing the speaker cone from an audio speaker frame;
providing a replacement speaker cone, said replacement speaker cone comprising a hemp fiber in a concentration of at least 50%; and
positioning the replacement speaker cone in the speaker frame.
